(19) United States
(12) Patent Application Publication
(10) Pub. No.: US 2007/0045468 A1
(43) Pub. Date: Mar. 1, 2007

(54) Transporting airline passengers comfortably and efficiently on long distance flights

(76) Inventor: Paul Travis Casey, Santa Monica, CA (US)

Correspondence Address: ROBERT J. LAUSON;LAUSON & ASSOCIATES, 1600 ROSECRANS AVENUE, FOURTH FLOOR, MANHATTAN BEACH, CA, 90266, US

(21) Appl. No.: 11/212,542

(22) Filed: Aug. 26, 2005

(51) Int. Cl. B64D 11/06

(52) U.S. Cl. 244/122 R

(57) ABSTRACT

A method of long-haul air travel includes providing a first partial fleet of planes with a substantial number of generally lie-flat seats and providing a second partial fleet of planes with a substantially lesser number of generally lie-flat seats. The first partial fleet of planes are routed generally continuously and primarily in an east-bound direction, and the second partial fleet of planes are routed generally continuously and primarily in a west-bound direction. The method offers the advantages that passengers flying long east-bound (typically overnight) are readily able to sleep in the lie-flat seats, and airlines save money on long west-bound flights (typically during daytime) when there is less demand for the lie-flat seats. Optionally, the method includes handing off the planes between airlines at stops along the generally continuous travel. Preferably the total number of seats on the first partial fleet of planes is approximately equal to the total number of seats on the second partial fleet of planes. This may be accomplished by the first partial fleet of planes preferably having generally larger planes, or alternatively the first partial fleet of planes having a greater number of planes.

### CROSS REFERENCE TO RELATED DOCUMENTS

This application is based on provisional patent application Ser. No. ______ filed Aug. 25, 2004.

### BACKGROUND OF THE INVENTION

1. Field of the Invention

This invention relates to passenger airline travel, and more particularly to methods of operation and configurations of aircraft interiors to accommodate passengers in greater comfort while reducing airline capital and operating costs for inter-continental flights.

2. Description of the Related Art

Globalization of economic activity has lead to a greatly expanded demand for inter-continental business air travel. These travelers are willing to pay several times the price of a coach ticket for amenities in first and business classes to ensure that they arrive at their destination well rested after many hours in the air, traveling across several time zones. International airline profitability is largely dependent upon revenue from first and business class. In an effort to win and maintain the loyalty of long distance business travelers, some airlines have recently begun to invest in seating that can be converted into flat beds after take-off to provide the necessary comfort for a sound sleep during an overnight flight. This seating, however, can require spacing (pitch) between rows of at least 78 inches, compared with traditional seating arrangements with a typical pitch of between 50 and 60 inches in first class and as little as 38 to 40 inches in business class. When an aircraft interior is re-configured by replacing partially reclining traditional first and business class seats with flat-bed seats, fewer total passengers can be accommodated on the aircraft.

Getting a good night's sleep on a flat bed while flying a long distance is now a principal marketing theme for an increasing number of airlines. First and business class customers are so focused on comfort on these long flights that the seat configuration often is a major consideration in choosing between airlines offering otherwise comparable service, particularly if an overnight flight is required. For example, there are web sites at which customers can compare detailed seat features between various airlines. As competition to provide the most comfortable seats intensifies, the airlines must find a way to maintain profit margins while incurring higher costs associated with this service improvement.

The reconfiguration of first and business class to provide lie-flat seats is the cause of significant increases in capital and operating costs for the airlines. The seats cost more and occupy more space in the cabin. To maintain the same passenger capacity, airlines must either utilize larger aircraft or they must deploy more aircraft in service. Both result in increased capital and operating costs. Larger aircraft require more fuel, have higher weight-based landing fees, and there are increases in other expenses related to operations. While demand for lie-flat seating is strong for overnight flights, which are typically eastbound, there is less passenger demand for this amenity during the daytime (usually westbound) flights as people sleep less during the day. Some airlines have begun to charge more on overnight flights for ticket upgrades to first and business class that provide lie-flat seating than they charge for identical seats on daytime westbound flights between the same cities. This pricing difference is a reflection of the greater value held by passengers for lie-flat seating for nighttime as opposed to daytime flights. With daytime flights comprising as much as half of their long distance flights, airlines are providing lie-flat seating that many first and business class customers really don't need. For daytime flights of six to 12 hours, a partially reclining seat with leg and foot support is sufficient for the nap that passengers are likely to take. The practice of assigning aircraft configured with lie-flat seats in business and first class to fly long-distance segments back and forth on alternating overnight and daytime flights, for example across the Atlantic between North America and Europe, is inefficient.

An additional strategy in the competition for international business travelers is the formation of partnerships or alliances among airlines with strategically located home bases. The three major partnerships are OneWorld with members including American Airlines, British Airways, Cathy Pacific and Qantas; Star Alliance with members including United, Lufthansa, Singapore and Thai; and SkyTeam with members including Delta, Air France and Korean Air. Among the alleged benefits to customers is the ability to seamlessly transfer between flights operated by different airlines in the same alliance, compatible loyalty schemes (i.e. frequent flyer programs), access to airport lounges at more airports, more flights, easier transfers at hubs, a single check-in when connecting to a partner's flight, true global reservations networks, consistent quality control, etc. Advantages of alliance membership for an airline include the ability to expand their network overseas without adding new service, through so-called “code sharing” with alliance partners that allow each airline to sell tickets under its own name for travel that occurs in all partners' networks. These alliances have generally been a success for the airlines and customers alike, and thus the airlines are looking for more ways to cooperate globally and integrate services in the future.

### OBJECTS OF THE INVENTION

Accordingly, it is an object of the present invention to provide improved comfort for passengers on very long flights, particularly eastbound;

It is a further object of the present invention to provide improved operating efficiency for airlines in transporting first and business class passengers on long distance flights;

It is a further object of the present invention to provide lower capital cost for long-range aircraft fleets;

It is a still further object of the present invention to provide specially-configured aircraft for daytime and for nighttime long distance flights;

It is still a further object of the present invention to provide an opportunity for airlines to work together and cooperate in global travel.

Other objects will become apparent upon reading the following detailed description and upon reference to the accompanying drawings.

### SUMMARY OF THE INVENTION

A method of long-haul air travel to improve comfort for passengers and improve efficiency for airlines includes providing a first partial fleet of planes with a substantial number of generally lie-flat seats and providing a second partial fleet of planes with a substantially lesser number of generally lie-flat seats. The method further includes routing the first partial fleet of planes generally continuously and primarily in an east-bound direction, and routing the second partial fleet of planes generally continuously and primarily in a west-bound direction. The method offers the advantages that passengers flying long east-bound (typically overnight) are readily able to sleep in the lie-flat seats, and airlines save money on long west-bound flights (typically during daytime) when there is less demand for the lie-flat seats. Optionally, the method includes handing off the planes between airlines at stops along the generally continuous travel, for example, between partners in an airline alliance. Further optionally, the method includes providing additional planes and routing the planes to travel between popular cities.

The first partial fleet of planes preferably has generally larger planes than the second partial fleet of planes, or alternatively the first partial fleet of planes has a greater number of planes than the second partial fleet of planes, this to accommodate the larger number of lie-flat seats. Preferably the total number of seats on the first partial fleet of planes is approximately equal to the total number of seats on the second partial fleet of planes. Further preferably the generally lie-flat seats fully recline and are at approximately a 78 inch pitch, or alternatively are flatbed seats installed at approximately an 81 inch pitch.

These and other advantages of the present invention will become apparent upon reading the following detailed description and upon reference to the accompanying drawings.

### BRIEF DESCRIPTION OF THE SEVERAL VIEWS OF THE DRAWINGS

FIG. 1 is an overall perspective view of a business and coach class cabin of a conventional passenger aircraft indicative of the prior art;

FIG. 2 is a perspective view of a typical first class seat in several positions indicative of the prior art;

FIG. 3 is a top view of a typical interior arrangement of a large Boeing passenger aircraft indicative of the prior art;

FIG. 4 is a top view of an interior arrangement of a larger Boeing passenger aircraft for overnight flights in accordance with the preferred embodiment of the present invention;

FIG. 5 is a chart showing roundtrip flights, back-and-forth, between California and East Asia, East Asia and Europe, and Europe and California indicative of the prior art;

FIG. 6 is a chart showing continuous eastbound flights between California, Europe and East Asia in accordance with the preferred embodiment of the present invention;

FIG. 7 is a chart showing continuous westbound flights between California, East Asia and Europe in accordance with the preferred embodiment of the present invention.

FIG. 8 is a top view of a typical interior arrangement of a large Airbus passenger aircraft indicative of the prior art;

FIG. 9 is a top view of an interior arrangement of a larger Airbus passenger aircraft for overnight flights in accordance with the preferred embodiment of the present invention.

### DESCRIPTION OF PREFERRED EMBODIMENT(S)

The detailed description set forth below in connection with the appended drawings is intended as a description of preferred embodiments and is not intended to represent the only forms in which the present invention may be constructed and/or utilized. The description sets forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

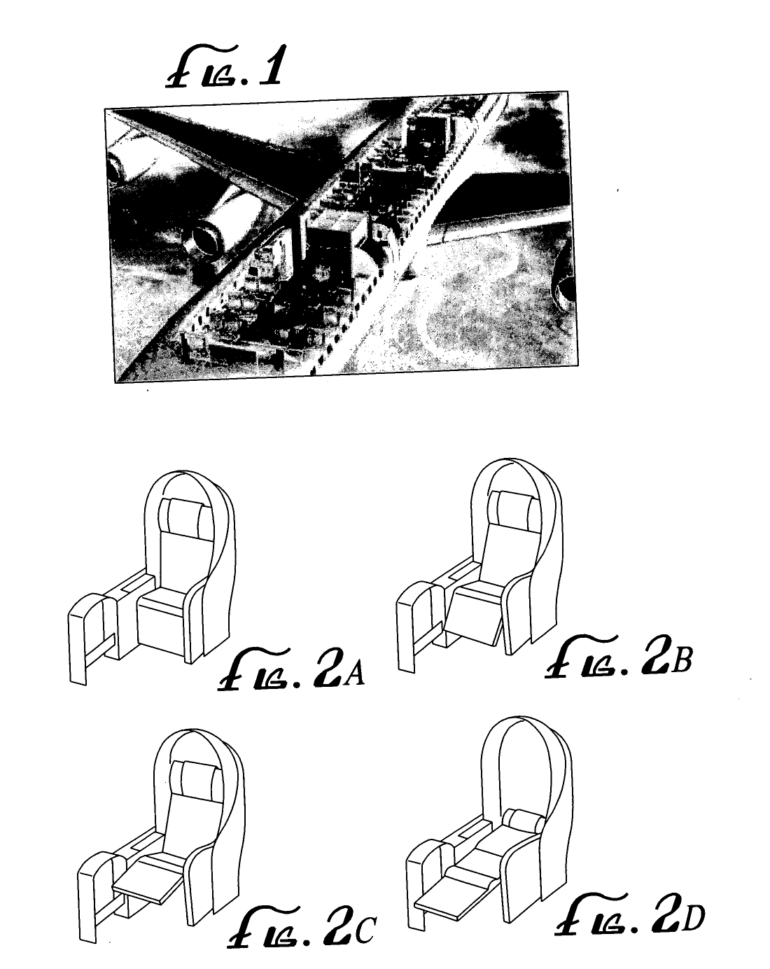

Referring to FIGS. 1-9, the prior art and preferred embodiments of the present invention will be described. Referring initially to FIG. 1, shown are portions of a business class and coach class cabin for a conventional Boeing 767-400ER passenger aircraft. The size of the seats and aisle spacing in business class provides added comfort to those passengers, while the coach class includes many smaller seats and less spacing between a much larger numbers of passengers.

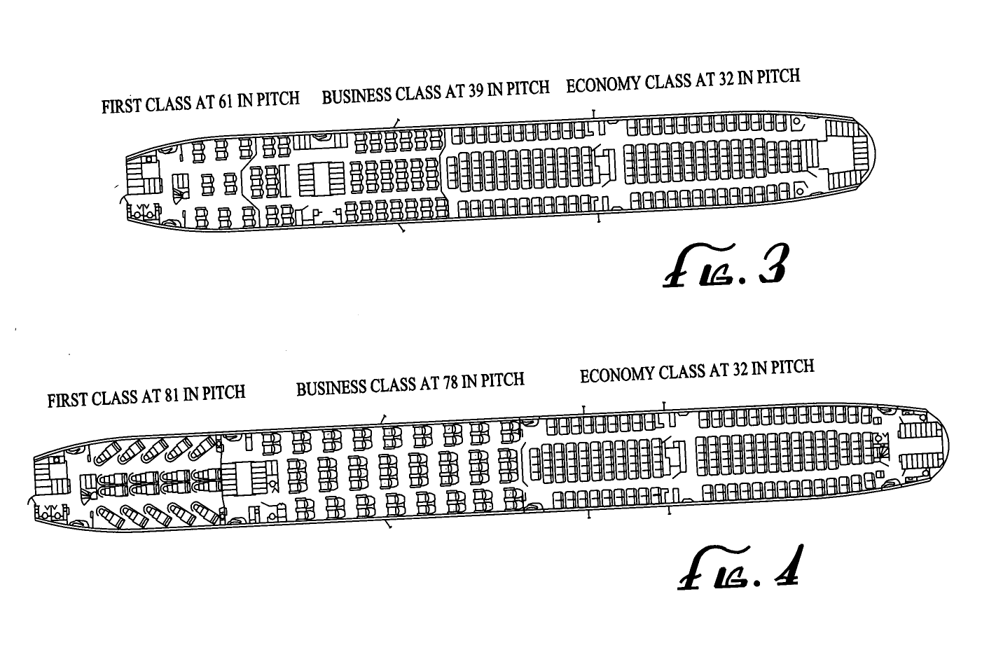

FIG. 2 A-D shows a first class seat in its upright, reclined, leg rest up and 180 degrees flat bed positions. The seat can be used in a reclined position to watch television, in a more reclined position for naps, and in the upright position for business computer work or meals. These positions would satisfy most passengers during the daytime hours, even for long distance flights. The 180 degrees lie-flat position (FIG. 2D) is necessary for sleeping comfort during the nighttime hours of very long flights, usually eastbound.

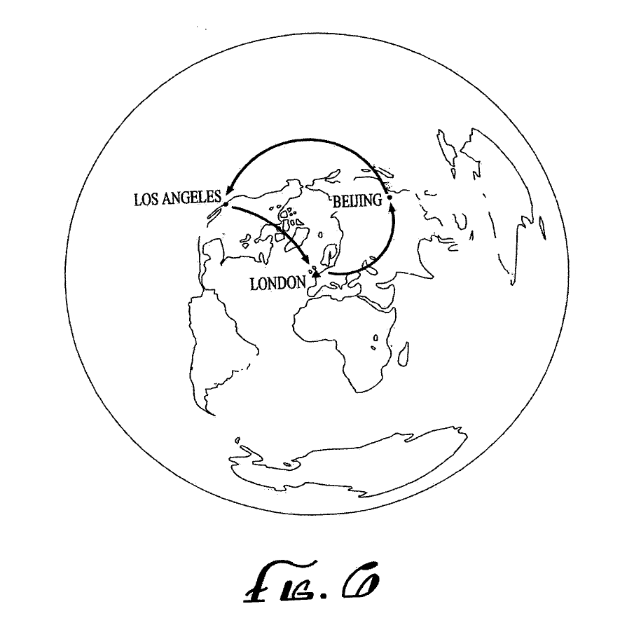

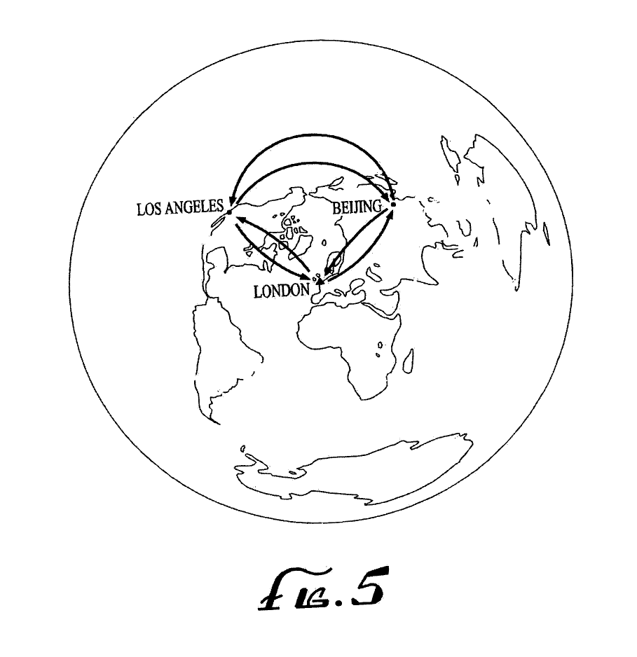

FIG. 3 shows a conventional seating arrangement for a Boeing 777-200ER accommodating 301 passengers in three classes. This configuration provides about a 60 inch pitch in first class, a 39 inch pitch in business class and a 32 inch pitch in economy class. FIG. 4 shows a modified seating arrangement for a longer, stretch version Boeing 777-300ER accommodating approximately the same number of passengers similarly divided in three classes. FIG. 5 shows conventional round-trip, back-and-forth flights being flown between Los Angeles, London and Beijing. To clarify what is being indicated by FIG. 5, note that generally the same plane is used for both legs of the round trip between city pairs. Also note the eastbound flights are generally primarily in the dark of night, especially in the winter half of the year, while the westbound flights are primarily in the daylight, again especially during the summer half of the year.

In FIG. 4 the size of the first class and business cabins have been dramatically increased, with flatbed seats on a about 81 inch pitch installed in first class, and fully-reclining seats on a about 78 inch pitch installed in business class. In accordance with the present invention, this plane would be used for overnight flights. This would be accomplished by primarily flying in an eastbound direction, continuously around the world approximately every 48 hours. For example, a plane would depart Los Angeles for London and arrive the next morning, depart London in the afternoon for Beijing and arrive the next morning, and then depart Beijing in the afternoon for Los Angeles again arriving the morning of the same day having crossed the international dateline. See FIG. 6. Passengers would appreciate arriving at their destination with adequate sleep and would be willing to pay airlines a premium for the flatbed amenities.

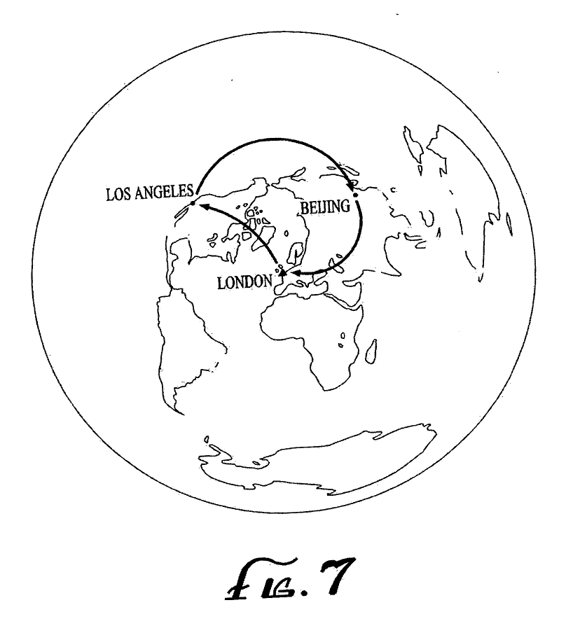

Smaller aircraft generally equipped like today's 777200ER (FIG. 3) would handle the corresponding westbound trips, continuously around the world in the other direction. There would be adequate comfort for relaxation, naps, etc., but flatbed sleeping would generally not be provided except for possibly a few seats for customers who were willing to pay extra. For example, a plane would leave Los Angeles in the morning for Beijing and arrive at midday, then depart Beijing in the afternoon to London and arrive in the late afternoon, and finally depart London in the early evening and arrive back to Los Angeles in the evening, in time for passengers to get a good sleep at home or in their hotel. See FIG. 7. Three aircraft flying this sequence would provide passengers with three choices for departure times.

Reduced operating and capital costs would be achieved by the airlines in employing smaller aircraft in the westbound direction. Since airlines typically have restrictions on their rights to offer service to passengers traveling between foreign countries, the aircraft flying continuously one direction or the other would in some cases have to be handed off between companies, perhaps among partners in a strategic alliance. Scheduling software would create appropriate routing, assign departure times, properly load the planes, select appropriate equipment, and the like. Travel demand between particular continents may differ, that is, more people wanting to fly from California to Europe than Europe to Asia. In this case, additional aircraft operating according to the prior art could provide supplemental capacity on the most popular long distance routes.

Having described the inventive concept and equipment needed for the preferred embodiment(s), implementing or practicing the preferred embodiment(s) may include the following:
providing an airplane to be utilized for overnight, generally eastbound flights, that is generously configured with lie-flat seats, such as is shown in FIG. 4 or similar;
providing an airplane to be utilized for daytime, generally westbound flights, that has a denser seating configuration with fewer or no lie-flat seats, such as is shown in FIG. 3 or similar;
providing a similar passenger capacity for the eastbound and westbound flights by utilizing larger airplanes such as is shown in FIG. 4 or similar for overnight generally eastbound flights while utilizing relatively smaller airplanes, such as is shown in FIG. 3 or similar for daytime generally westbound flights;
providing an operational schedule in which airplanes designated for overnight flights will fly in a generally eastbound direction, continuously circling the globe, such as is shown in FIG. 6 or similar; and/or,
providing a corresponding operational schedule in which airplanes designated for daytime flights will fly in a generally westbound direction, continuously circling the globe, such as is shown in FIG. 7 or similar.

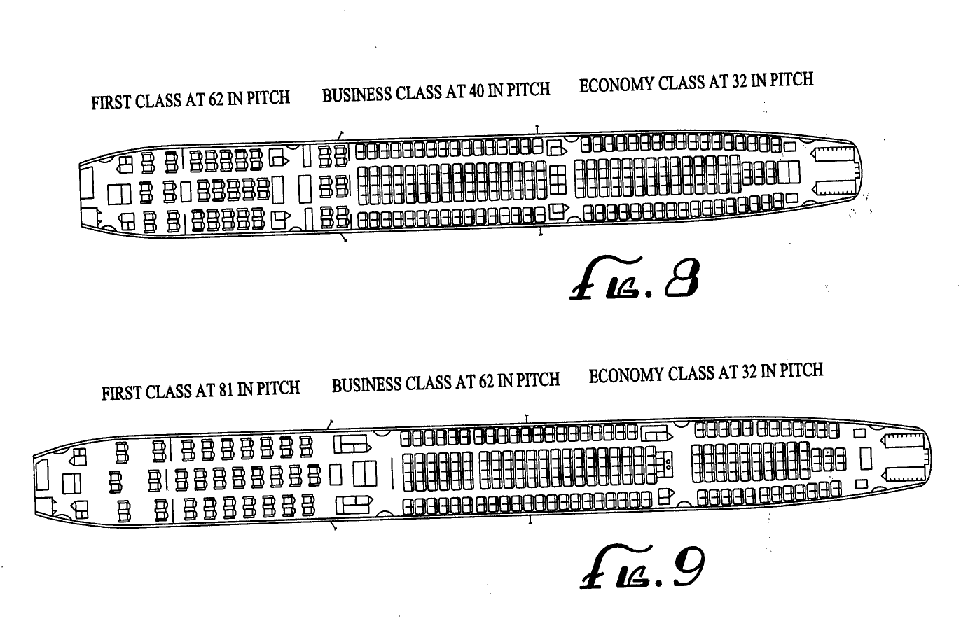

While the present invention has been described with regards to particular embodiments, it is recognized that additional variations of the present invention may be devised without departing from the inventive concept. Although large Boeing aircraft and circumventing the world in northern hemisphere routes have been used as examples in describing the preferred embodiments, the invention is not intended to be so limited but rather apply to all aircraft and all routes, including polar routes, as appropriate. In another example, an Airbus A340-300 (FIG. 8) with the denser seating configuration could operate daytime, generally westbound flights while an Airbus A340-600 (FIG. 9) that has the same width or cross section but is 38 feet longer could be configured with the flat bed seating and accommodate the same number of passengers flying in the westbound direction.

What is claimed is:

1. A method of long-haul air travel to improve comfort for passengers and improve efficiency for airlines, comprising the steps of:
providing a first partial fleet of planes with a substantial number of generally lie-flat seats;
providing a second partial fleet of planes with a substantially lesser number of generally lie-flat seats;
routing the first partial fleet of planes generally continuously and primarily in an east-bound direction; and, routing the second partial fleet of planes generally continuously and primarily in a west-bound direction;
whereby passengers flying long east-bound typically overnight are readily able to sleep in the lie-flat seats, and airlines save money on long west-bound flights typically during daytime when there is less demand for the lie-flat seats.

2. The method of long-haul air travel of claim 1 further comprising the step of handing off the planes between airlines at stops along the generally continuous travel.

3. The method of long-haul air travel of claim 1 further comprising the steps of providing additional planes and routing the planes to travel between popular cities.

4. A fleet of specially-equipped planes for long haul flights comprising:
a first partial fleet of planes having a substantial number of generally lie-flat seats;
a second partial fleet of planes having a substantially lesser number of generally lie-flat seats;
wherein the total number of seats on the first partial fleet of planes is approximately equal to the total number of seats on the second partial fleet of planes.

5. The fleet of specially-equipped planes of claim 4 wherein the generally lie-flat seats fully recline and are at approximately a 78 inch pitch.

6. The fleet of specially-equipped planes of claim 4 wherein the generally lie-flat seats are flatbed seats installed at approximately an 81 inch pitch.

7. The method of long-haul air travel of claim 4 wherein the first partial fleet of planes has generally larger planes than the second partial fleet of planes.

8. The method of long-haul air travel of claim 4 wherein the first partial fleet of planes has a greater number of planes than the second partial fleet of planes.
